(19) United States
(12) Patent Application Publication
(10) Pub. No.: US 2014/0033933 A1
(43) Pub. Date: Feb. 6, 2014

(54) Apparatus for texturing roti

(71) Applicants: Diane King, Houston, TX (US); Leslyn Brown, Decatur, GA (US)

(72) Inventors: Diane King, Houston, TX (US); Leslyn Brown, Decatur, GA (US)

(21) Appl. No.: 13/507,834

(22) Filed: Aug. 2, 2012

(51) Int. Cl. A21C 15/00

(52) U.S. Cl. 99/485

(57) ABSTRACT

A Roti texturizing apparatus 10 is provided having a front, back, side and bottom planar shaped walls 12, 14, 16 and 20 respectively. The planar shaped walls 12, 14, 16 18 and 20 are coupled together so that a semi circularly shaped elongated opening 30 is formed therebetween. Additionally a planar shaped top 36 is pivotably coupled to the back planar shaped wall 16 so that the planar shaped top can be moved to cover the semi-circularly shaped opening 30. A gripping member 44 is provided to allow a user to hold the texturizing apparatus 10 so that it may be moved in a predetermined manner to facilitate texturizing.

### TECHNICAL FIELD

This invention relates to a bread known as Roti and more particularly to an apparatus for texturizing Roti. Roti is a bread which can be used as a carrier for meats, fish, foul, fruits and vegetables. Additionally, it is eaten as a compliment to meals of all kinds. Roti's popularity is constantly growing because of its unique taste which results from its flaky texture which is different from other kind of breads.

Achieving the described flaky texture for Roti can be somewhat difficult and uncomfortable because in order to properly texturize Roti the Roti must be manipulated in a predetermined manner while it is hot. Normally this is accomplished by hand thus making it uncomfortable for the person during the texturizing. Accordingly, an apparatus is needed which allows the Roti to be maintained at a desired temperature while being texturized without causing discomfort to a person's hands during the texturizing process.

### BACKGROUND OF THE ART

Attempts have been made to provide food manipulating devices which eliminates the need to accomplish the task by hand. One such device is disclosed in U.S. Pat. No. D527,958 S. This patent discloses a salad shaker. The salad shaker of this invention includes a lower enclosure for receiving salad fixings. The lower enclosure is provided with an internal vertical pole like member and an upper member which is coupable to the lower enclosure. Once the salad fixings are put into the lower enclosure the upper member can then be coupled to the lower enclosure so the salad fixings can be tossed in a predetermined motion to prepare the salad that is desired.

Another arrangement is disclosed in U.S. Pat. No. D581,219 S. This patent discloses a food spinner. The food spinner of this invention includes a lower bowl for receiving a desired food and a top, having a handle thereon. The top is coupable to the bowl for keeping the desired food therein. Once the food is in the bowl and the top is coupled thereto a user can hold the handle and the bottom of the bowl and the food can be spinned in a predetermined motion to mix the food as desired.

These arrangements do in fact eliminate the need to process food by hand and are suitable for their intended uses. However they are not suitable for use as an apparatus for texturizing Roti as disclosed by Applicant. Accordingly, there is still a need for an apparatus which will allow a user to texturize Roti without discomfort to the user during the texturizing process.

### DISCLOSURE OF THE INVENTION

An apparatus for texturizing Roti in accordance with the principles of this invention is provided with a front planar shaped wall which has curved corner members formed on upper and lower side portions thereof. The texturizing apparatus also includes a back planar shaped wall aligned with and spaced from the front planar shaped wall. Additionally, the apparatus includes a first side planar shaped wall which is aligned to engage one end of the front and back planar shaped walls and a second side planar shaped wall which is aligned to engage another end of the front and back planar shaped walls. A bottom planar shaped wall is aligned to engage bottom portions of the front, back and first and second side planar shaped walls. The front, back, side and bottom planar shaped walls are coupled together so that a semi circularly shaped opening is formed therein. Additionally a planar shaped top is provided having end portions thereof aligned adjacent to the back planar shaped wall. A coupling means pivotably couples back portions of the planar shaped top to the back planar shaped wall so that the planar shaped top can be selectively moved to cover the opening. The apparatus is further provided with a gripping member formed on the front planar shaped wall, and the planar shaped top which allows a user to hold the apparatus and maneuver it in a predetermined manner.

### BRIEF DESCRIPTION OF THE INVENTION

The details of the invention will be described in connection with the accompanying drawing in which:

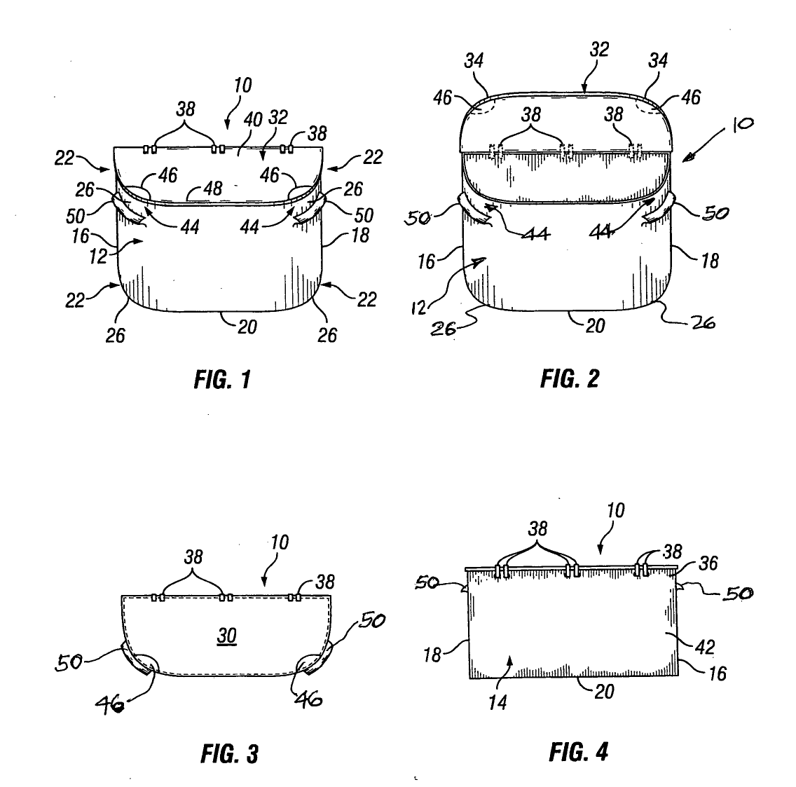

FIG. 1 is a front perspective view illustrating a Roti texturizing apparatus in accordance with the principles of the invention.

FIG. 2 is a second front perspective view illustrating a Roti texturizing apparatus with the top open in accordance with the principles of the invention.

FIG. 3 is a top view of a Roti texturizing apparatus in accordance with the principles of the invention.

FIG. 4 is a rear view of the Roti texturizing apparatus in accordance with the principles of the invention.

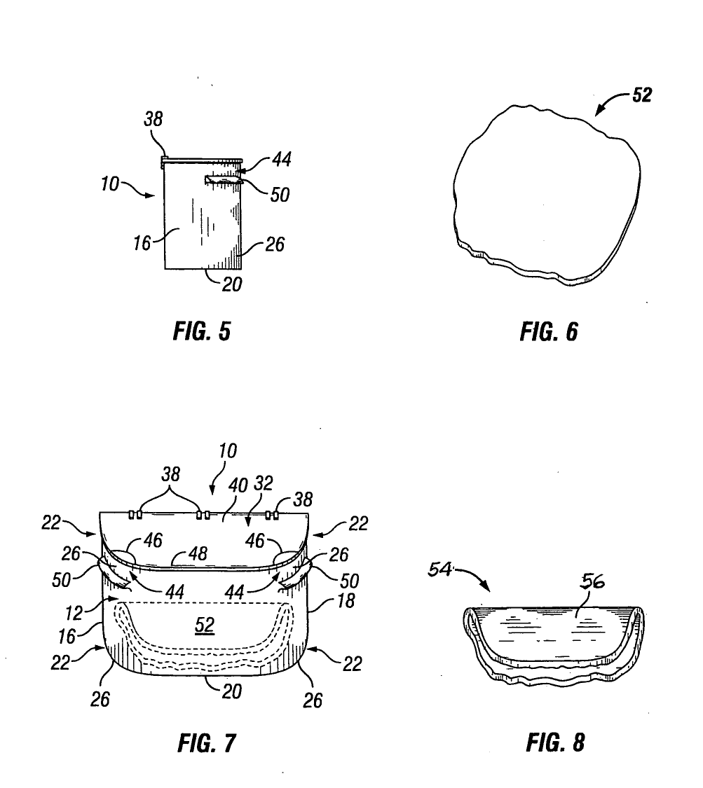

FIG. 5 is a side view of a Roti texturizing apparatus in accordance with the principles of the invention.

FIG. 6 is a perspective view of a piece of untexturized Roti to be texturized in the texturizing apparatus in accordance with the principles of the invention.

FIG. 7 is a third perspective view illustrating a Roti texturizing apparatus with a piece of untexturized Roti in a folded configuration placed therein in accordance with the principles of the invention.

FIG. 8 is a perspective view of a piece of folded texturized Roti after the Roti has been texturized in the Roti texturizing apparatus in accordance with the principles of the invention.

### BEST MODE FOR CARRYING OUT THE INVENTION

Referring to FIGS. 1, 2, 3, 4 and 5 a Roti texturizing apparatus, generally designated, by the numeral, 10 is illustrated. The texturizing apparatus 10 is provided with front and back planar shaped walls, generally designated, by the numerals 12 and 14, (FIG. 4) side planar shaped walls 16 and 18 and a bottom planar shaped wall, 20. The front planar shaped wall 12 is formed on upper and lower portions thereof, generally designated, by the numeral 22 with a curved corner member 26 on each side thereof. The planar shaped walls 12, 14, 16, 18 and 20 are aligned and coupled together so that an elongated semi circularly shaped open area 30 is formed therebetween (FIG. 3). This allows the apparatus 10 to have a somewhat semi circular shape which is substantially the same shape as a folded piece of Roti. The planar shaped walls 12, 14, 16, 18 and 20 may, for example, be coupled together with an adhesive or an appropriate sealant.

The apparatus 10 is also provided with a planar shaped top, generally designated, by the numeral, 32 having curved corner members 34 (FIG. 2) which have the same curvature as the upper front wall corner members 26. This allows the planar shaped top 32 to properly engage the front planar shaped wall 12 when the top is closed as is illustrated in FIG. 1.

The planar shaped top 32 is pivotably coupled to an upper end portion 36 (FIG. 4) of the back planar shaped wall 14 of the apparatus 10 by coupling members 38 aligned to engage outside portions 40 (FIG. 4) of the planar shaped top 32 and outside portions 42 (FIG. 4) of the back planar shaped wall. The coupling members 38 may be, for example, spring biased hinges which are biased so that when the planar shaped top is closed it secures the top over the open area 30 of the apparatus 10.

The apparatus 10 is also provided with a gripping member, generally, designated, by the numeral 44. The gripping member 44 is provided with a pair of spaced recessed members 46 formed on an upper surface 48 (FIG. 1) of the planar shaped top 32 and a pair of spaced outwardly protruding members 50 coupled to the upper portions 22 of the front planar shaped wall 12. The gripping member 44 is provided to allow a user to place the user's thumbs in the recessed members 46 and grab the protruding members 50 with the user's fingers so that the apparatus 10 can be picked up and manipulated in a predetermined manner for facilitating texturizing of the Roti, generally designated, by the numeral 52 (FIG. 6).

The apparatus 10 may be, for example ten inches in width, four inches in depth and six inches in length, and may be made, for example, of a hard heat resistant plastic.

As illustrated in FIGS. 6, 7 and 8, when texturizing the Roti 52 in accordance with the principles of this invention the process begins with the untexturized Roti (FIG. 6) being folded and then placed inside of the texturizing apparatus 10 (FIG. 7). The texturizing apparatus 10 can then be picked up and shaken ten to twelve times so that the untexturized Roti 52 alternately strikes the planar shaped top 32 and the bottom planar shaped wall 20 of the apparatus. The effect of this striking motion is enhanced because the apparatus 10 is substantially the same semi circular shape as the folded Roti 52 placed in the apparatus. This striking motion in the apparatus 10 causes the formation of texturized Roti 54 having a flaky surface 56 which is the desired texture for the Roti.

Once the texturization in the apparatus 10 is completed the texturized Roti 54 is removed from the apparatus and allowed to cool. The Roti 54 can then be wrapped until it is ready for consumption.

It should be understood that various changes and modifications can be made without departing from the spirit and scope of the invention as defined in the claims.

What is claimed:

1. A Roti texturizing apparatus including:
a front planar shaped wall member;
a back planar shaped wall member aligned with and spaced from the front planar shaped wall member;
a first side planar shaped wall member aligned to couplingly engage one side of the front and back planar shaped wall members;
a second side planar shaped wall member couplingly aligned to engage another side of the front and back planar shaped wall members;
a bottom planar shaped wall member aligned to couplingly engage outer lowermost portions of the front and back and first and second side planar shaped wall members so that an opening is formed therebetween;
a planar shaped top;
a coupling member having portions coupled to the back planar shaped wall member, and other portions coupled to the planar shaped top so that the planar shaped top can be pivoted to engage uppermost portions of the front planar shaped wall member to selectively cover the opening; and
a gripping member having first portions coupled to the front planar shaped wall member and second portions formed in the planar shaped top so that the texturizing apparatus can be held and then moved in a predetermined motion to facilitate texturizing of the Roti.

2. A texturizing apparatus as defined in claim 1 wherein the front planar shaped wall member includes:
a first pair of spaced curved corner members formed on an uppermost portion thereof; and
a second pair of spaced curved corner members formed on a lowermost portion thereof.

3. A texturizing apparatus as defined in claim 2 wherein the front, back, side and bottom planar shaped wall members are aligned together in couplingly engagement so that an elongated semi circularly shaped opening is formed therebetween.

4. A texturizing apparatus as defined in claim 3 wherein the planar shaped top includes a pair of spaced curved corner members formed on outermost front portions thereof which are aligned for coupling engagement adjacent the first pair of spaced curved corner members formed on an uppermost portion of the front planar shaped wall member.

5. A texturizing apparatus as defined in claim 4 wherein the coupling member includes:
a first plurality of spaced coupling members, each having one end thereof coupled to the back planar shaped wall member; and
a second plurality of spaced coupling members, each one of the second plurality of spaced coupling members being pivotably coupled at one end thereof to another end of an adjacently aligned one of the first plurality of spaced coupling members and each one of the second plurality of spaced coupling members being coupled at another end thereof to the planar shaped top so that the planar shaped top can be selectively moved to securely cover the opening.

6. A texturizing apparatus as defined in claim 5 wherein the gripping member includes:
a pair of spaced recessed members formed on an outermost portion of the planar shaped top; and
a pair of outwardly protruding members formed on outermost portions of the front planar shaped wall member.
